(19) United States
(12) Patent Application Publication
(10) Pub. No.: US 2024/0283090 A1
(43) Pub. Date: Aug. 22, 2024

(54) PLATE-STRUCTURED ELECTRODE-COATED ZEOLITE SEPARATORS FOR LITHIUM-METAL BATTERIES

(71) Applicant: ARIZONA BOARD OF REGENTS ON BEHALF OF ARIZONA STATE UNIVERSITY, Scottsdale, AZ (US)

(72) Inventors: Jerry Lin, Scottsdale, AZ (US); Kishen Rafiz, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/562,479

(22) PCT Filed: May 18, 2022
(86) PCT No.: PCT/US2022/072403

§ 371 Date: Nov. 20, 2023

Related U.S. Application Data
(60) Provisional application No. 63/191,085, filed on May 20, 2021.

(51) Int. Cl. H01M 50/449; H01M 4/38; H01M 4/505; H01M 4/525; H01M 50/403; H01M 50/431; H01M 50/443; H01M 50/46; H01M 50/491; H01M 50/497

(52) U.S. Cl. CPC H01M 50/449; H01M 4/382; H01M 4/505; H01M 4/525; H01M 50/403; H01M 50/431; H01M 50/443; H01M 50/46; H01M 50/491; H01M 50/497

(57) ABSTRACT

A lithium-metal battery electrode-supported separator includes an electrically conductive substrate and a separator coated on the substrate. The separator includes plate-shaped zeolite particles, and the zeolite particles define intra-particle pores. A lithium-metal battery includes a first electrode, a separator coated on first electrode, a second electrode that includes lithium metal and is in direct contact with the separator, and an electrolyte in contact with the first electrode and the second electrode.

### CROSS-REFERENCE TO RELATED APPLICATION

This application claims the benefit of U.S. Patent Application No. 63/191,085 filed on May 20, 2021, the contents of which are incorporated by reference herein in their entirety.

### TECHNICAL FIELD

This invention relates to zeolite separators for lithium-metal batteries.

### BACKGROUND

Lithium metal batteries (LMBs) are rechargeable batteries with a metallic lithium anode. The anode is separated from the cathode by a porous separator, which allows passage of the electrolyte.

FIG. 1 depicts lithium-ion battery (LIB) 100 with a liquid electrolyte. Lithium-ion battery 100 includes anode 102 and cathode 104. Anode 102 and cathode 104 are separated by separator 106. Anode 102 includes anode collector 108 and anode material 110 in contact with the anode collector. Cathode 104 includes cathode collector 112 and cathode material 114 in contact with the cathode collector. Electrolyte 116 is in contact with anode material 110 and cathode material 114. Anode collector 108 and cathode collector 112 are electrically coupled by closed external circuit 118. Anode material 110 and cathode material 114 are materials into which, and from which, lithium ions 120 can migrate. During insertion (or intercalation), lithium ions move into the electrode (anode or cathode) material. During extraction (or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 1 depict movement of lithium ions through separator 106 during charging and discharging.

### SUMMARY

This disclosure describes plate-shaped silicalite particles synthesized using a modified hydrothermal method to produce particles of a specific particle-size range. Silicalite belongs to the MFI group of zeolites and it consists essentially of silicon and oxygen in its framework. These particles have a plate-shaped morphology and intra-particle pores capable of allowing transport of lithium ion complexes present within the electrolyte.

Separators fabricated from plate-shaped silicalite, which have intra-particle pores, resulted in better performance compared with γ-alumina separators having a similar pore-size, porosity and tortuosity but lacking intra-particle pores. The performance of these separators at charge and discharge C-rates of up to 3C for dendrite propagation prevention was comparable, but the stability of the LMB with the silicalite for 100 cycles was superior. Hence, the intra-particle pores assist in homogenizing the lithium-ion flux at the separator anode interface, which leads to stable cycling of the lithium metal battery even at high C-rates without any dendrite propagation. Dendrite propagation can limit the operational safety and long-term cycling stability of lithium-metal batteries. This disclosure describes electrode-coated plate-structured silicalite separators with liquid electrolyte for high performance, safe lithium-metal batteries. The silicalite separators are mechanically strong and tortuously porous, and therefore effective in preventing passage of dendrites. Nickel-manganese-cobalt-oxide/lithium full cells with a plate-structured silicalite separator show stable cycle performance without passage of dendrites up to 3 C-rate of charging and discharging.

Embodiment 1 is a lithium-metal battery electrode-supported separator comprising:
an electrically conductive substrate; and
a separator coated on the substrate, wherein the separator comprises plate-shaped zeolite particles, and the zeolite particles define intra-particle pores.

Embodiment 2 is a separator of embodiment 1, wherein a thickness of the separator is in a range of 20 μm to 60 μm.

Embodiment 3 is separator of embodiment 1 or 2, wherein an average diameter of the zeolite particles is in a range of 0.5 μm to 3.5 μm.

Embodiment 4 is a separator of embodiment 3, wherein the average diameter of the zeolite particles is in a range of 1 μm to 3 μm.

Embodiment 5 is a separator of any one of embodiments 1 through 4, wherein the intra-particles pores have a radius in a range of 0.5 nm to 0.8 nm.

Embodiment 6 is a separator of any one of embodiments 1 through 5, wherein the separator defines inter-particle pores between the zeolite particles.

Embodiment 7 is a separator of embodiment 6, wherein a radius of the inter-particle pores is in a range of 100 nm to 700 nm.

Embodiment 8 is a separator of embodiment 7, wherein the radius of the inter-particle pores is in a range of 200 nm to 600 nm.

Embodiment 9 is a separator of embodiment 8, wherein the radius of the inter-particle pores is in a range of 300 nm to 500 nm.

Embodiment 10 is a separator of any one of embodiments 1 through 9, wherein the substrate comprises nickel, manganese, and cobalt oxide.

Embodiment 11 is a separator of any one of embodiments 1 through 10, wherein the zeolite comprises silicalite.

Embodiment 12 is a method of making the electrode-supported separator of any one of embodiments 1 through 11, comprising:
preparing a slurry of the plate-shaped zeolite particles;
spreading the slurry on an electrically conductive substrate to yield a coated substrate; and
drying the coated substrate to yield the electrode-supported separator.

Embodiment 13 is a lithium-metal battery comprising:
a first electrode;
a separator coated on first electrode, wherein the separator comprises plate-shaped zeolite particles, and the zeolite particles define intra-particle pores;
a second electrode comprising lithium metal, wherein the second electrode is in direct contact with the separator; and
an electrolyte in contact with the first electrode and the second electrode.

Embodiment 14 is a battery of embodiment 13, wherein the first electrode is a nickel manganese cobalt oxide electrode.

Embodiment 15 is a battery of embodiment 13 or 14, wherein the electrolyte is a liquid electrolyte.

Embodiment 16 is a battery of any one of embodiments 13 through 15, wherein a thickness of the separator is in a range of 20 μm to 60 μm.

Embodiment 17 is a battery of any one of embodiments 13 through 16, wherein a tortuosity of the separator (EIS Method) is at least 6.

Embodiment 18 is a battery of any one of embodiments 13 through 17, wherein a porosity of the separator is in a range of 40% to 60%.

Embodiment 19 is a battery of any one of embodiments 13 through 18, wherein the zeolite comprises silicalite.

Embodiment 20 is a battery of any one of embodiments 13 through 19, wherein the separator inhibits formation of lithium dendrites during charging and discharging of the battery.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic cross-sectional view a lithium-ion battery (LIB) with a liquid electrolyte.

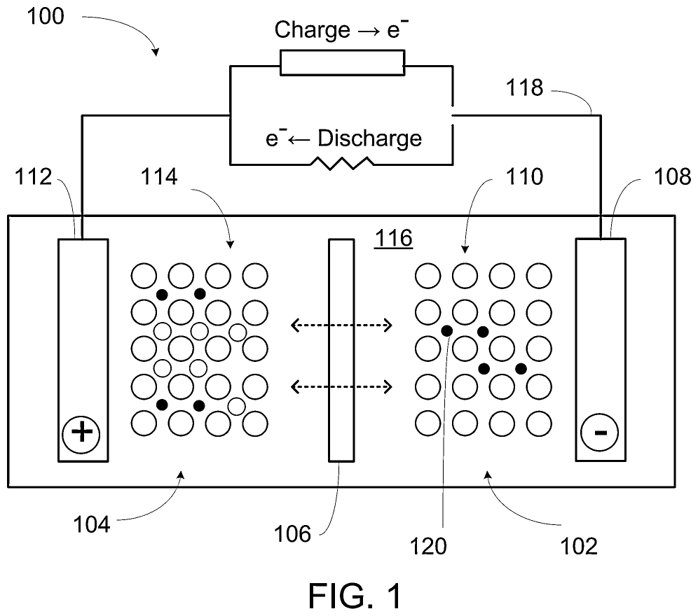

FIG. 2 is a schematic cross-sectional view of an electrode-supported separator.

FIG. 3A is a top-view scanning electron microscopy (SEM) image of synthesized plate-shape silicalite powder having a particle size of about 2.1 μm. FIG. 3B shows a plot of article size distribution of the silicalite powder. FIG. 3C shows an X-ray diffraction (XRD) pattern of the synthesized silicalite powder.

FIG. 4A is a cross-sectional SEM image of the plate-shaped silicalite separator coated on the nickel manganese cobalt oxide (NMC) electrode. FIG. 4B shows pore-size distribution for α-alumina, γ-alumina, and plate-shaped silicalite when coated as a 40 μm thick separator on aluminum foil. FIG. 4C shows an XRD pattern of the synthesized plate-shaped silicalite separator when coated to 40 μm on the NMC electrode. FIG. 4D shows an XRD pattern of the synthesized plate-shaped silicalite separator when coated to 40 μm on the NMC electrode and compressed to 400 psi.

FIG. 5 shows Nyquist plots obtained from electrochemical impedance spectroscopy for the plate shaped silicalite, α-alumina, γ-alumina and PP separators. The plots were generated by fitting the data with EC-LAB. The cells were made with NMC as cathode, lithium metal as anode and plate shaped silicalite, α-alumina, γ-alumina and PP separators.

FIG. 6A shows voltage versus capacity density curves for the 1^{st} and 100^{th} cycle for γ-alumina and plate-shaped silicalite separators when cycled at 0.2 C-rate. FIG. 6B shows an XRD pattern for the extracted cycled electrode coated plate-shaped silicalite separator post 100 cycles at 3 C-rate.

FIGS. 7A and 7B show charge and discharge profiles for the lithium metal cell with plate-shaped silicalite separator at 1 C-rate for current vs. time and voltage vs. time, respectively. FIGS. 7C and 7D show charge and discharge profiles for the lithium metal cell with plate-shaped silicalite separator at 2 C-rate for current vs. time and voltage vs. time, respectively.

FIGS. 8A and 8B show charge and discharge profiles for the lithium metal cell with plate-shaped silicalite separator at 3 C-rate for current vs. time and voltage vs. time, respectively.

FIGS. 9A-9D are top-view SEM micrographs at various magnifications of the extracted plate-shaped silicalite separator surface post 100 cycles at 3 C-rate.

### DETAILED DESCRIPTION

This disclosure describes dendrite-inhibiting separators made of plate-shaped silicalite particles directly coated on a nickel manganese cobalt oxide (NMC) cathode using a blade-coating method. This polymer-free separator inhibits or prevents dendrite propagation in lithium metal batteries (LMBs).

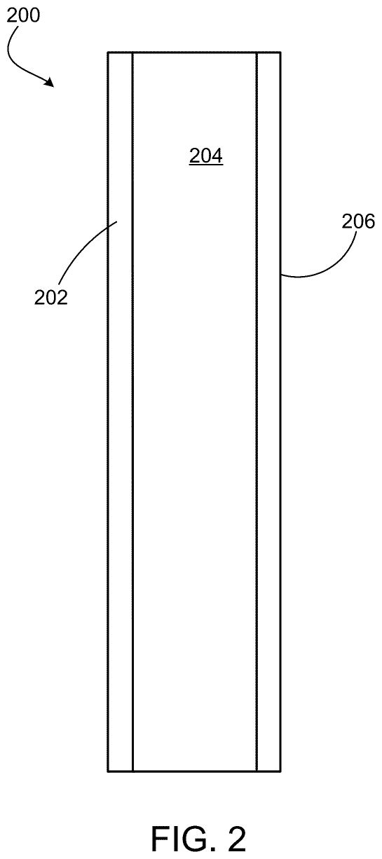

As described herein, a lithium-metal battery electrode-supported separator includes an electrically conductive substrate that can be formed on a layer, and a separator coated on the substrate. FIG. 2 depicts a cross-sectional view of electrode-coated silicalite separator 200. Electrode-coated silicalite separator 200 includes silicalite separator 202 on and electrically conductive substrate 204. The electrically conductive substrate can be coated on a current collector 206.

The silicalite separator 202 includes plate-shaped zeolite particles (e.g., silicalite particles) that define intra-particle pores. A thickness of the separator is typically in a range of 20 μm to 60 μm. An average diameter of the zeolite particles is in a range of 0.5 μm to 3.5 μm (e.g., 1 μm to 3 μm). The intra-particle pores have a radius in a range of 0.5 nm to 0.8 nm. In some cases, the separator defines inter-particle pores between the zeolite particles. A radius of the inter-particle pores is typically in a range of 100 nm to 700 nm (e.g., 200 nm to 600 nm, or 300 nm to 500 nm). A porosity of the separator can be in a range of 40% to 60%, and a tortuosity of the separator, measured using an electrochemical impedance spectroscopy (EIS) method, can be at least 6.

The electrically conductive substrate can be used as an electrode (e.g., a cathode). A thickness of the electrically conductive substrate is typically in a range of 10 μm to 100 μm. Suitable materials for the electrically conductive substrate 204 include one or more of nickel, manganese, and cobalt oxide (e.g., lithium cobalt oxide (LiCoO₂), lithium manganese oxide (LiMn₂O₄), lithium nickel cobalt aluminum oxide (LiNiCoAlO₂), and lithium nickel manganese cobalt oxide (LiNiₓMn_{y}Co_{z}O₂).

In one example, current collector 206 is composed of aluminum.

The electrode-supported separator can be fabricated by preparing a slurry of the plate-shaped zeolite particles, spreading the slurry on an electrically conductive substrate to yield a coated substrate, and drying the coated substrate to yield the electrode-supported separator.

The separator can be used in a lithium-metal battery that includes a first electrode, a second electrode in direct contact with the separator, and an electrolyte in contact with the first electrode and the second electrode. The electrolyte can be a liquid electrolyte or a solid electrolyte. The separator inhibits formation of lithium dendrites during charging and discharging of the battery.

The zeolite-based separator technology described herein may be used in the construction of pouch, cylindrical, or prismatic LMB cells with capacities in the range of about 0.1-500 Ah. Suitable cathodes for these cells include lithium iron phosphate (LiFePO₄), lithium cobalt oxide (LiCoO₂), lithium manganese oxide (LiMn₂O₄), lithium nickel cobalt aluminum oxide (LiNiCoAlO₂, also referred to as “NCA”), and lithium nickel manganese cobalt oxide (LiNiₓMn_{y}Co_{z}O₂, also referred to as “NMC”). In some examples, the NMC cathode has a composition such as LiNi_{0.333}Mn_{0.333}Co_{0.333}O₂ (NMC111 or NMC333), LiNi_{0.5}Mn_{0.3}Co_{0.2}O₂ (NMC532 or NCM523), LiNi_{0.6}Mn_{0.2}Co_{0.2}O₂ (NMC622), or LiNi_{0.8}Mn_{0.1}Co_{0.1}O₂ (NMC811). In some embodiments, the separator technology described herein may be used in lithium ion batteries in which the anode is only a metal foil, such as copper. In some embodiments, the separator technology described herein may be used in lithium ion batteries in which the anode comprises silicon, silicon carbon composite, natural graphite, synthetic graphite, lithium titanate, graphene, mesocarbon microbeads (MCMB), or combinations thereof.

In other embodiments, the plate-shaped silicalite particles described herein may be used as an additive in polymer-based separators for LMBs and lithium ion batteries. The particles may comprise about 0.1-75 weight % of the separator. The polymer may include polypropylene, polyethylene, nylon, polyvinyl chloride, poly(tetrafluoroethylene), polyester, or a combination thereof. The separator may have a thickness in the range of about 15-35 μm.

As described herein, microporous zeolite silicalite particles with a plate shaped morphology are used to make electrode-coated separators using an industrially scalable blade-coating methodology. The shape of the particles results in a tortuous separator upon its coating, due to the stacking of these particles along their faces. Also, the micropores within the silicalite plates can allow the transport of lithium-ion complexes through them. This allows the lithium-ion flux at the separator and anode interface to be more uniform, thereby resulting in more uniform lithium plating, lower solid electrolyte interface (SEI) and charge-transfer resistance, and a lower probability of dendrite formation. The silicalite particle density is lower than that of the γ-alumina particles. This results in a higher gravimetric energy density for LMBs made with silicalite-based separator than LMBs made with γ-alumina particle-based separators with the same thickness.

### Examples

### Synthesis of Plate-Shaped Silicalite and Preparation of the Coating Slurry

The synthesis of plate-shaped silicalite particles was done hydrothermally by mixing 10 gm of tetraethyl orthosilicate (reagent grade, 98% by wt.; Aldrich), 4 gm of tetrapropyl-ammonium hydroxide (1 M in H₂O; Sigma Aldrich) and 170 gm of de-ionized water, in a sealed beaker for 24 hours at room temperature (about 25° C.). The obtained clear solution after 24 hours was transferred to an autoclave and heated in an oven at 155° C. for 10 hours to obtain the required plate-shape silicalite particles of about 2 μm size. The autoclave was allowed to cool down to room temperature for another 12 hours. The autoclave was then opened and the formed silicalite powder at the bottom was separated from the mother liquor by decantation. To remove the organic components left post reaction, the silicalite powder was washed by mixing it with de-ionized water and centrifuging the mixture at 16.8 m RCF (meter relative centrifugal force). This washing process was performed three times. After recovering the powder and de-ionized water mixture from the centrifuge, it was dried in a beaker on a hot plate while stirring to remove the bulk of the water in the solution at 100° C. for ˜24 hours.

The powder was dried at 120° C. in a vacuum to remove moisture in the powder. This was followed by calcination at 600° C. for 18 hours with atmospheric air as the medium to remove trace organics from the powder. To form the slurry of silicalite, 3 gm of powder with 1 gm of 5 wt. % polyvinyl alcohol (PVA) aqueous solution (molecular weight: 77000-79000 Da) (ICN Biomedical Inc., USA) and 1 gm deionized water was mixed until a homogenous slurry with minimal air bubbles was formed. This slurry was ground using a mortar and pestle for ˜10 min by hand.

### Formation of the Electrode-Coated Separator and its Characterization

Lithium-metal chips of 0.1 mm thickness and 15.6 mm diameter and nickel manganese cobalt oxide (NMC) electrodes were procured from MTI Corporation, USA. The components for constructing the CR-2032 cell were procured from X2 Labwares, Singapore. The electrolyte used was 1M LiPF₆ salt in equal volume of ethyl carbonate (EC), diethyl carbonate (DEC) and dimethyl carbonate (DMC); EC:DEC:DMC=1:1:1, v/v/v) procured in a sealed container from MTI, USA. To establish a control-cell performance, the commercially used PP-2500 separator of 25 μm thickness was procured from Celgard LLC, USA, and used to make similar cells to those with the silicalite separator.

The slurry of the plate-shaped silicalite powder was dropped across one of the edges of the aluminum foil or NMC electrode and then spread down the length of the aluminum foil or NMC electrode using a caliper-adjustable doctor blade (Gardco LLC, USA). To produce the electrode-supported separators the initial blade gap was kept at 50 μm. The coated separator was dried for 8 hours, in a humidity controlled chamber at 40° C. and 60% relative humidity. The separator was dried at 70° C. for 12 hours using a temperature controlled vacuum oven (Thermo Fisher Scientific, USA) to remove moisture. The thickness of the coated separator was measured by a micrometer (Mitutoyo, Japan) with an accuracy of 1 μm. The final thickness was found to be 40 μm, as about 10 μm compression was observed due to the drying of the separator.

For measuring the porosity of the silicalite separator, the coated-separator on the aluminum foil was peeled off without causing physical damage to the separator. This free-standing silicalite separator was obtained to match the physical free standing nature of PP-2500 separator. The porosity (Ø) of the separator was obtained from the measured bulk density using the weight and dimensional volume of the coated silicalite separator and Eq. 1

$$∅ = 1 - \frac{{ρ}_{bulk}}{{ρ}_{p a r t i c l e}} \qquad ( 1 )$$

in which ρ_{bulk} and ρ_{particle} are the bulk density and particle density, respectively.

To measure tortuosity, the PP-2500 and silicalite separators were soaked in the electrolyte for 24 hours inside the glovebox. The soaked separator was inserted between two stainless steel electrode plates that had the same shape and cross-section as the free standing separator. The ohmic resistance of the separator was obtained by using EIS at 25° C. EIS instrument (PARSTAT 2263 EIS station, Princeton Applied Research, USA) scanning parameters were set to a starting frequency of 100 kHz and end frequency of 100 mHz, with an AC amplitude of 10 mV rms. The tortuosity (T) of the separator is related to its measured ohmic resistance (R) and the conductivity of the electrolyte “K” by Eq. 2:

$$τ = \frac{R \times A \times K \times ∅}{d} \qquad ( 2 )$$

in which “d” is the thickness of the separator, “A” is the cross-sectional area of the separator, and “Ø” is the porosity of the separator. Eq. 2 was used to find the tortuosity of the various separators soaked with the electrolyte.

Scanning electron microscopy (SEM) (Philips, USA, FEI XL-30) was used to examine cross-sectional morphology of the coated separator on separator samples sputter-coated with gold to facilitate the development of the micrographs. Additionally, the plate-shaped silicalite particles synthesized via the hydrothermal route were characterized for particle size by performing a top-view SEM post coating on aluminum foil using the blade-coating method. Top-view SEM images were quantified for particle size distribution using GATAN GMS software for particle size distribution with the particle size interval being 0.25 μm.

X-ray diffraction (XRD) patterns were obtained (Bruker AXS-D8, Cu Kα radiation, USA) for the silicalite powder to confirm the phase structure of the synthesized material. XRD was also done for silicalite separator coated on NMC and the silicalite separator coated on NMC post 400 psi compression to observe any change in peak intensities. The electrode-coated silicalite separator was extracted from the coin-cell, post cycling it at 3 C-rate for 100 cycles, to confirm the stability of the separator. The coated aluminum foils were cut into 16 mm disks and tested for their pore size distribution using a mercury porosimeter (Micrometrics Auto Pore V, USA). This characterization was done by coating the silicalite powder on aluminum foil and not NMC so that the pore size distribution of the NMC did not interfere with the measurement of the pore size distribution of the respective powder. The mercury porosimetery was done at both high-pressure mode and low-pressure mode to detect pore sizes ranging from the nanometer to micrometer dimensions.

### Coin-Cell Construction and Post-Cycling Cell Internal Analysis

Silicalite coated electrode disks of 16 mm diameter were cut from the corresponding coated electrode sheets and kept in the vacuum oven at 70° C. for 12 hours. It was then taken inside an argon-filled glovebox (Innovative Technology Inc., USA) and kept in it for a period of 24 hours to remove atmospheric gases or moisture in the electrode-supported separator disks. The other components of the cell were previously placed in the glovebox for assembly. The cut 16 mm electrode-supported separator disk was placed inside the bottom case of the CR-2032 cell and 150 μl of electrolyte (1M LiPF₆ salt in equal volumes of ethyl carbonate (EC), diethyl carbonate (DEC) and dimethyl carbonate (DMC); EC:DEC:DMC=1:1:1, v/v/v) was pipetted onto the surface of the top facing silicalite coated surface of the NMC electrode.

To prevent damage to the separator, a lithium metal chip (MTI, USA) of 0.1 mm thickness and 15.6 mm diameter was placed on top of the separator surface. Two spacers and one spring (X2 Labwares, Singapore) were placed on the lithium metal anode followed by the placement of the top case of the CR-2032 cell to closely envelop the full-cell. The coin-cell was crimped to a pressure of 400 psi. The assembled lithium-metal coin-cell filled with the electrolyte was taken out of the glovebox and its charge and discharge characteristics were tested by a battery testing system (Neware Co., China). To test the performance of the separator at varying C-rates (from 0.2 C-rate to 3 C-rate), the cells with silicalite separator were tested at various C-rates between 2.0 to 4.2 volts for 100 cycles, using the standard CC-CV (constant current-constant voltage) method.

A PARSTAT 2263 EIS station (Princeton Applied Research, USA) was used in the AC mode to perform EIS measurements of the assembled cells. Nyquist plots for the assembled full cells were generated by utilizing a frequency range of 100 kHz to 100 MHZ. To examine the propagation of dendrites through the separator, the cycled coin-cell with the silicalite separator was disassembled inside the glovebox. The lithium metal anode was removed from the cell and the separator coated cathode was placed on a SEM sample holder stage. This sample holder was then taken for gold sputtering inside a vacuum sealed container and then examined for dendrites on the surface of the separator which was in contact with the lithium metal anode.

### Synthesis of Silicalite Powder, Coating of Separator Characterization

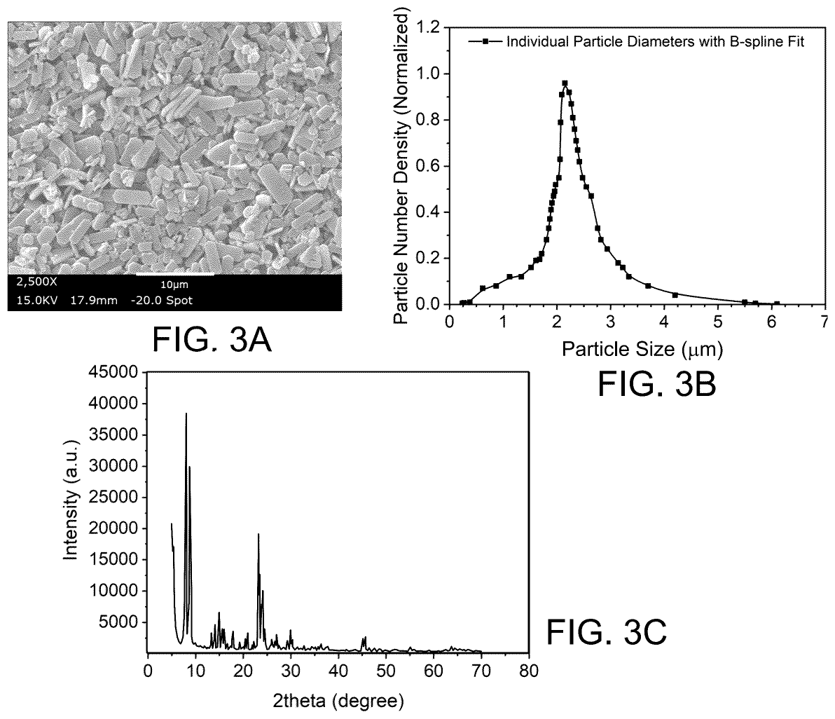

FIG. 3A an SEM micrograph of the synthesized plate-shaped silicalite particles formed as a coated separator on the NMC electrode. These particles have a thickness of about 100 nm to about 150 nm, a width of about 400 nm to about 500 nm, and a length of about 2.1 μm. Some of the larger particles have been broken due to the wet grinding process which results in several rectangular plate shape particles. FIG. 3B shows the particle size distribution of the particles shown in FIG. 3A. The particle size, defined as the length of the plate-shaped particle, affected the coating quality, indicating that these particles fill the electrode surface pores more across their length. FIG. 3B shows that the particle size of the majority of the particles is in the 2.0 to 2.1 μm range. The particle size range of the plate shaped particles was designed to match the pore size of the NMC electrode so that a good quality coating of separator was achieved in a single coat. FIG. 3C shows the XRD pattern of the synthesized silicalite powder. The peak intensities are not large for one specific crystallographic plane as the powder sample is set as a powder disk in the XRD sample holder. Thus, no particular alignment of a particular plane can be achieved.

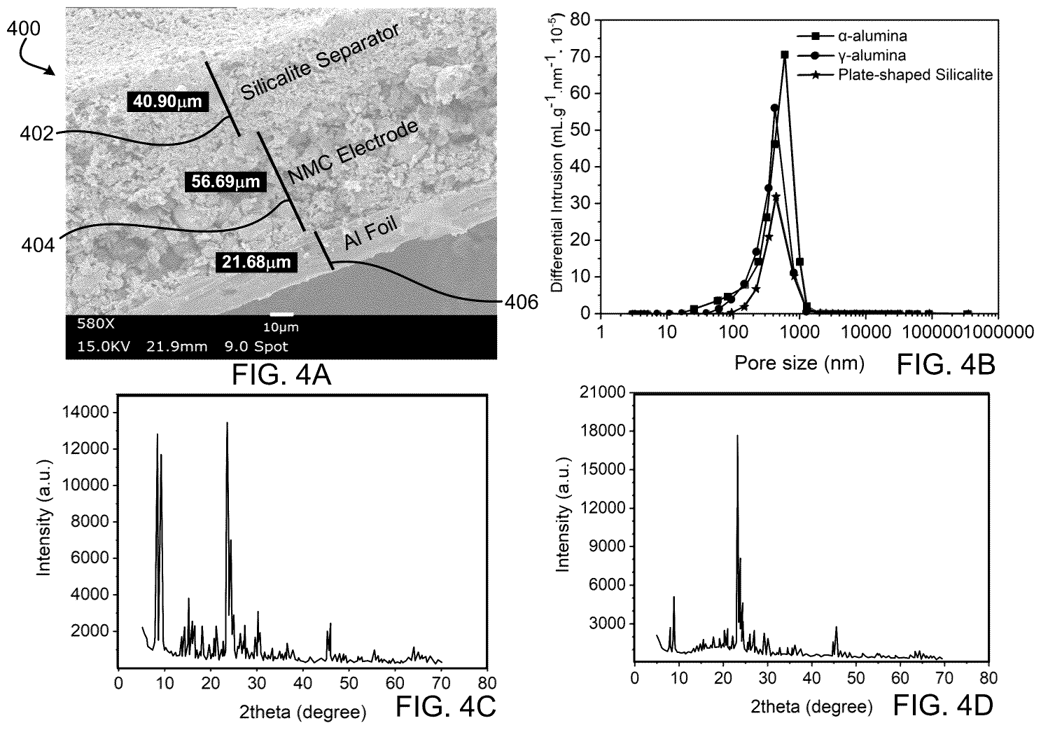

FIG. 4A is a cross-sectional SEM image of an electrode-supported separator 400 including a plate-shaped silicalite separator 402 coated on a NMC electrode 404. The NMC electrode 404 is coated on aluminum foil 406. The separator 402 is evenly coated over the NMC electrode 404 with a thickness of about ˜40 μm. FIG. 4B shows the pore-size distribution of the plate-shaped silicalite, the γ-alumina and α-alumina separators when coated on an aluminum foil, as obtained by mercury porosimetry. The mercury porosimetry was done at both high and low pressure to obtain both mesopores and macropores. The micropores in the plate-shaped silicalite particles have an average diameter in a range of about 0.5 nm to about 0.8 nm. The plate-shaped silicalite particles had a size and morphology such that the pore size of the resulting silicalite separator was similar to that of a previously studied γ-alumina separator: the pore size of the plate-shaped silicalite separator (˜450 nm) is very similar to the γ-alumina separator (˜430 nm). The silicalite separator was designed have a pore-size similar to the γ-alumina separator so that the effect of the silicalite intra-particle pores on lithium-ion transport could be evaluated. The particle size and morphology of the plate-shaped silicalite particles was also kept the similar to γ-alumina separator so that the resultant separator structure would have a similar tortuosity.

FIG. 4C shows the XRD pattern of the plate-shaped silicalite separator coated on the NMC electrode. The peaks are representative of known silicalite peaks, thus confirming the crystal structure of the synthesized plate-shaped silicalite. There are no peaks from the underlying NMC or aluminum foil materials. These peaks are not aligned along any particular crystal plane and are similar in pattern and intensity to the peaks observed in FIG. 3C. This shows that coating the separator on the NMC does not align the plate shaped particles in a particular plane. FIG. 4D shows the XRD pattern of the plate-shaped silicalite separator coated on the NMC electrode post compression to 400 psi in the coin-cell. The peaks from the 303 (h.k.l) plane become more significant post compression. Thus, after the compression of the separator the silicalite plate particles stack along that plane more as compared to the other planes, resulting in the XRD pattern as shown. No peaks from the NMC or aluminum foil are seen in any of the diffraction patterns.

### Electrochemical Characterization, Coin-Cell Performance and Separator Evaluation

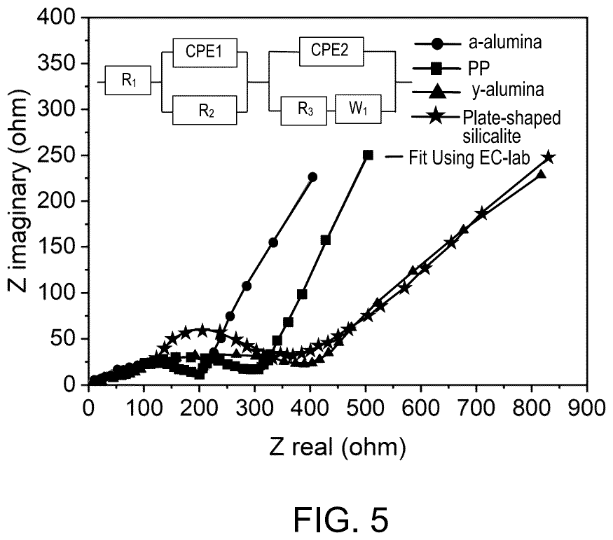

FIG. 5 shows the fitted Nyquist plots obtained from electrochemical impedance spectroscopy measurements for the coin-cells with silicalite, α-alumina, γ-alumina and PP separators. In FIG. 5, CPE is the constant phase element which represents the capacitive part of resistance. This CPE is used because the electrodes in the cell form a non-ideal parallel plate capacitor which results in the impedance of the movement of the lithium-ion complexes during charge and discharge. W is the Wahlberg element, which represents the infinite diffusion resistance of the lithium-ion complex into the electrode. The quantified values of the ohmic, SEI and charge-transfer resistance measurements post processing the raw data using EC-LAB are listed in Table 1. The ohmic resistance of the silicalite separator is marginally higher than that of the γ-alumina separator, even though they have the same thickness. This is due to its marginally lower porosity which results at least in part to the smaller broken down particles of silicalite occupying the pores within the separator. The pore size, porosity, thickness of separator, separator particle diameter and tortuosity for the various separators are listed in Table 2.

TABLE 1
Values of resistances as extracted from the fitted Nyquist
plots using EC-lab software for NMC/Li-metal cells with
PP, α-alumina and γ-alumina and silicalite separators

| | Equivalent | | | | Plate- |
|---|---|---|---|---|---|
| | resistance | | | | shaped |
| Resistance | from Zfit in | PP | α-alumina | γ-alumina | silicalite |
| in Circuit | EC-lab | (ohm/cm²) | (ohm/cm²) | (ohm/cm²) | (ohm/cm²) |
| R₁ | R_{ohmic} | 3.14 | 2.54 | 6.85 | 6.99 |
| R₂ | R_{SEI} | 179 | 147 | 239 | 221 |
| R₃ | R_{charge-transfer} | 301 | 206 | 392 | 363 |

TABLE 2
Quantified values of various separator physical characteristics
and the resulting tortuosity due to specific morphology
of the separator particles

| | | Particle | Pore | | Tortuosity |
|---|---|---|---|---|---|
| | Thickness | Diameter | Radius | Porosity | (EIS |
| Separator | (μm) | (μm) | (nm) | (%) | Method) |
| PP | 25 | N/A | 65 | 39 | 2.32 |
| α-alumina | 40 | 2.2 | ~610 | 66 | 2.95 |
| γ-alumina | 40 | 2.0 | ~430 | 54 | 6.95 |
| Plate - | 40 | 2.1 | ~450 | 50 | 6.31 |
| shaped | | | | | |
| Silicalite | | | | | |

The higher tortuosity of the silicalite separator explains its much higher ohmic resistance as compared to the α-alumina and PP separators. Even though the silicalite and the γ-alumina separators have the same pore size and similar porosity and tortuosity, the silicalite separator has a lower SEI and charge transfer resistance. This implies that the intra-particle pores are able to homogenize the lithium-ion flux at the separator and anode interface in a much better manner. The more uniform lithium-ion flux at this interface results in a more uniform and robust SEI and also a better availability of the lithium-ions at the lithium metal anode. Moreover, the similar tortuosity of the silicalite and the γ-alumina provides for an objective comparison to examine the role of the intra-particle pores in the better plating of the lithium metal anode during high rate cycling.

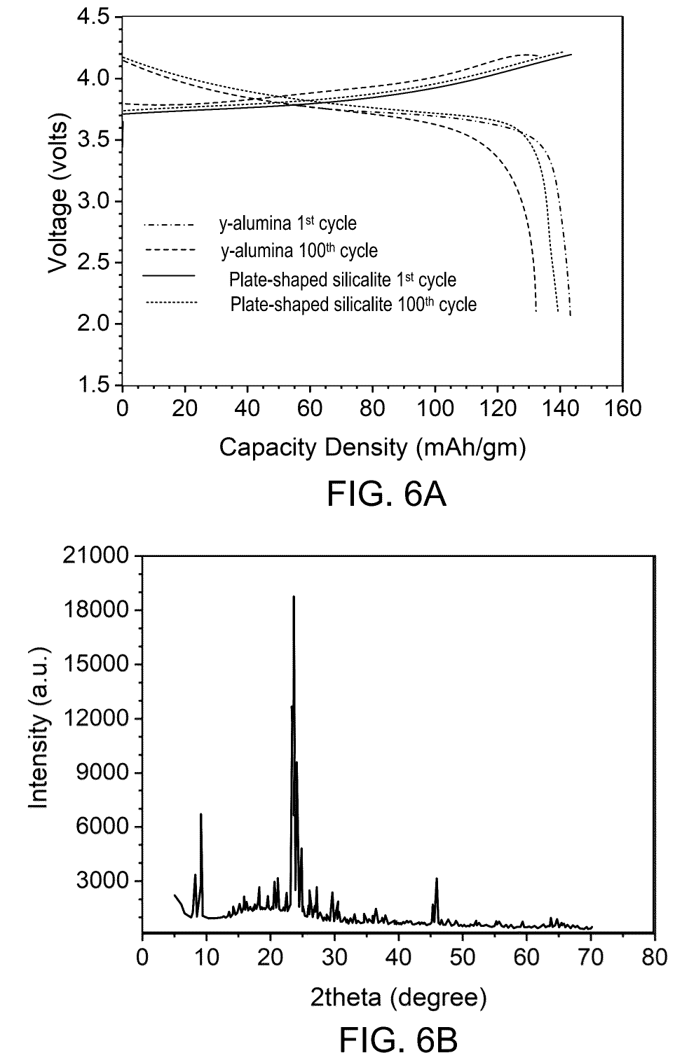

FIG. 6A shows the 1^{st} and 100^{th} CC-CV curves for the γ-alumina and plate-shaped silicalite separators when cycled at 0.2 C-rate for 100 cycles. The silicalite separator has a flatter discharge profile than that of the γ-alumina separator in the lithium metal cell. This can be attributed to the lower SEI and charge transfer resistance of the silicalite separator. Also, the silicalite separator lost about 4% less capacity at the end of 100 cycles compared with the γ-alumina separator. This results from the lower polarization losses and more uniform plating of lithium metal with the silicalite separator. The micropores of the silicalite separator help homogenize the lithium ion flux at the anode and thus, a more stable plating of lithium metal occurs resulting is lower loss of lithium metal anode as inactive lithium. FIG. 6B shows the XRD pattern of the cycled silicalite separator post 100 cycles at 3 C-rate. The peaks are similar to those obtained post compression as shown in FIG. 4D, thus indicating that the separator is stable during and post cycling. The peak intensities vary slightly between FIGS. 4D and 6B, but the peak locations remain the same, indicating that there is no structural change in the separator.

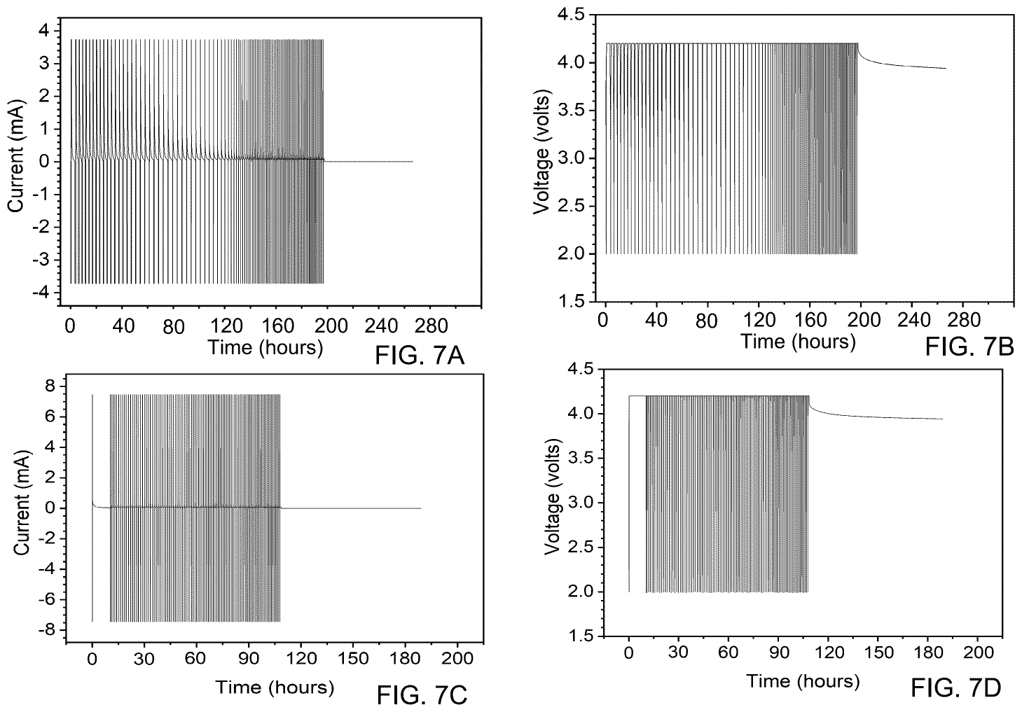

FIGS. 7A and 7B show charge and discharge profiles for the lithium metal cell with plate-shaped silicalite separator at 1 C-rate for current vs. time and voltage vs. time, respectively. FIGS. 7C and 7D show charge and discharge profiles for the lithium metal cell with plate-shaped silicalite separator at 2 C-rate for current vs. time and voltage vs. time, respectively. FIGS. 7A and 7C show that the lithium metal battery reaches its full rated charge and discharge current while cycling at 1 C-rate and 2 C-rate, respectively. This indicates that there is no substantial active lithium metal lost during the cycling from the anode, which would reduce the overall capacity of the battery. If substantial active material was being lost into the separator in the form of dendrites or being lost as non-reactive lithium metal defects, the battery would not have been able to reach the rate charge/discharge current. FIGS. 7B and 7D show that the voltage profiles for these batteries are stable during the entire 100 cycles. This indicates that no dendrites have propagated through the separator, since dendrite propagation would cause the battery to show a sudden drop in voltage even at maximum rate of charging. These voltage and current profiles indicate that this separator, due to its high tortuosity, prevents the formation and propagation of dendrites at these charge/discharge rates.

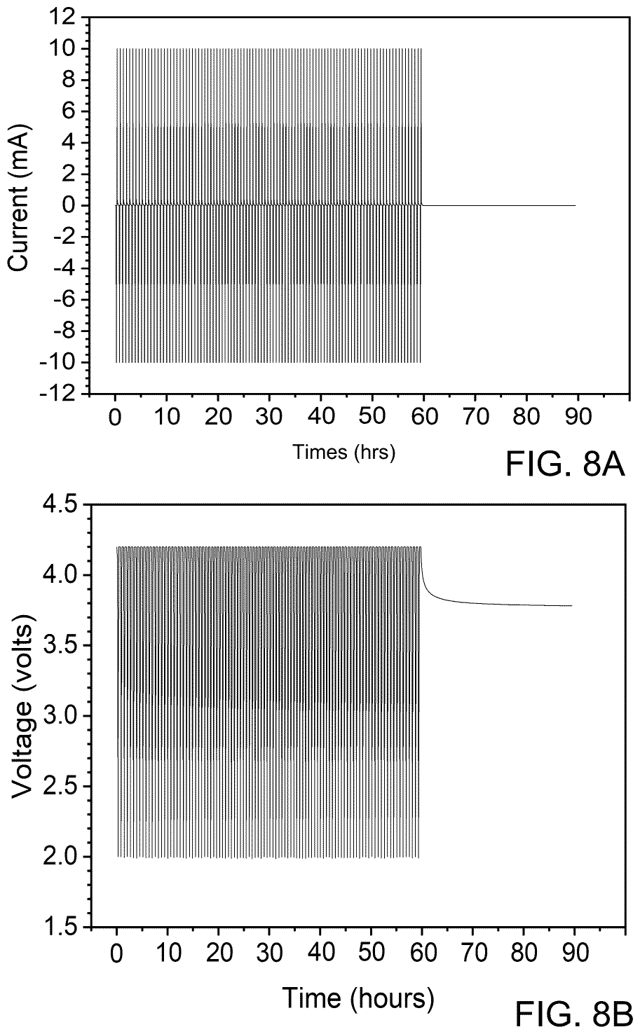

FIGS. 8A and 8B show the and current and voltage trends versus time, respectively, for the silicalite separator lithium metal cell, while charging and discharging at 3 C-rate. It is observed that the current during charge and discharge for the silicalite plate-shaped separator reaches its full range for the complete 100 cycles, whereas the γ-alumina cells starts losing its capacity at around the 75th cycle. Thus, the intra-particle pores of the silicalite particles facilitate better lithium-ion distribution across the separator and anode interface, which thus realizes better plating of the lithium metal anode at high C-rates. This reduced uneven plating reduces the amount of inactive lithium which would have dislodged from the lithium metal anode and deposited into the separator. Furthermore, the voltage profile is also stable for the entire range of 100 cycles, confirming that no dendrites have propagated through the separator. The cell voltage remains constant at around 3.8 volts post cycling, which is an indication of a stable cell.

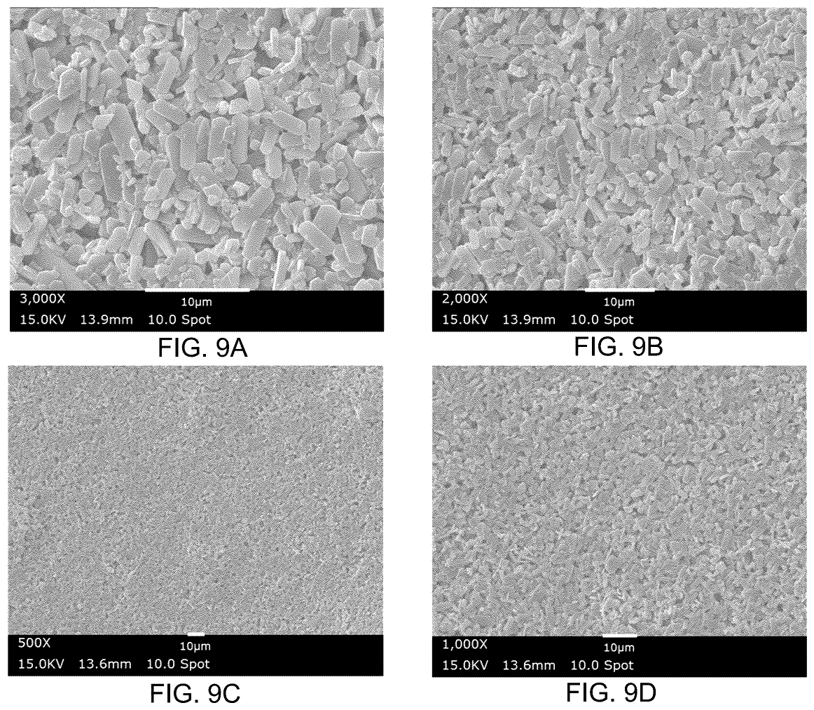

FIGS. 9A-9D are top-view SEM images of the extracted silicalite separator post cycling at 3 C-rate for 100 cycles. There are no visible foreign particles on the separator particles or within the visible pores of the separator. This confirms that the separator has no dislodged lithium metal or lithium metal dendrite remnants within the separator matrix. This results in concurrence with the stable voltage and current versus time profiles as observed previously in FIGS. 8A-8B.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A lithium-metal battery electrode-supported separator comprising:
an electrically conductive substrate; and
a separator coated on the substrate, wherein the separator comprises plate-shaped zeolite particles, and the zeolite particles define intra-particle pores.

2. The separator of claim 1, wherein a thickness of the separator is in a range of 20 μm to 60 μm.

3. The separator of claim 1, wherein an average diameter of the zeolite particles is in a range of 0.5 μm to 3.5 μm.

4. The separator of claim 3, wherein the average diameter of the zeolite particles is in a range of 1 μm to 3 μm.

5. The separator of claim 1, wherein the intra-particles pores have a radius in a range of 0.5 nm to 0.8 nm.

6. The separator of claim 1, wherein the separator defines inter-particle pores between the zeolite particles.

7. The separator of claim 6, wherein a radius of the inter-particle pores is in a range of 100 nm to 700 nm.

8. The separator of claim 7, wherein the radius of the inter-particle pores is in a range of 200 nm to 600 nm.

9. The separator of claim 8, wherein the radius of the inter-particle pores is in a range of 300 nm to 500 nm.

10. The separator of claim 1, wherein the substrate comprises nickel, manganese, and cobalt oxide.

11. The separator of claim 1, wherein the zeolite comprises silicalite.

12. A method of making the electrode-supported separator of claim 1, comprising:
preparing a slurry of the plate-shaped zeolite particles;
spreading the slurry on an electrically conductive substrate to yield a coated substrate; and
drying the coated substrate to yield the electrode-supported separator.

13. A lithium-metal battery comprising:
a first electrode;
a separator coated on first electrode, wherein the separator comprises plate-shaped zeolite particles, and the zeolite particles define intra-particle pores;
a second electrode comprising lithium metal, wherein the second electrode is in direct contact with the separator; and
an electrolyte in contact with the first electrode and the second electrode.

14. The battery of claim 13, wherein the first electrode is a nickel manganese cobalt oxide electrode.

15. The battery of claim 13, wherein the electrolyte is a liquid electrolyte.

16. The battery of claim 13, wherein a thickness of the separator is in a range of 20 μm to 60 μm.

17. The battery of claim 13, wherein a tortuosity of the separator (EIS Method) is at least 6.

18. The battery of claim 13, wherein a porosity of the separator is in a range of 40% to 60%.

19. The battery of claim 13, wherein the zeolite comprises silicalite.

20. The battery of claim 13, wherein the separator inhibits formation of lithium dendrites during charging and discharging of the battery.
